(19) United States
(12) Patent Application Publication
(10) Pub. No.: US 2003/0130946 A1
(43) Pub. Date: Jul. 10, 2003

(54) Configuration and method for debiting charges

(76) Inventors: Mathias Gabrysch, Munchen (DE); Peter Kasprzyk, Munchen (DE)

Correspondence Address: LERNER AND GREENBERG, P.A., Post Office Box 2480, Hollywood, FL, 33022-2480, US

(21) Appl. No.: 10/325,249

(22) Filed: Dec. 19, 2002

(30) Foreign Application Priority Data
Dec. 19, 2001 (DE) 101 62 554.5

(51) Int. Cl. G06F 17/60

(52) U.S. Cl. 705/40

(57) ABSTRACT

A configuration for debiting charges in a data and telecommunications network is disclosed which has a terminal, a network server, and a billing server that produces charge tickets for calls when using the terminal without a prior prepaid signal and which stores them in a ticket memory. In addition, the configuration has an IN system and software configured for debiting the charges from an electronic credit stored in the account memory when using the terminal after a prior prepaid signal.

### BACKGROUND OF THE INVENTION

Field of the Invention

The invention relates to a configuration and to a corresponding method for debiting charges in a data and telecommunications network.

Besides the Internet, telecommunications—particularly mobile telecommunications—today represent an area of rapid technical and economic development and a significant source of economic growth and new social developments. For a large number of people in industrial states, the mobile telephone (“mobile”) is increasingly becoming a universal communication and information instrument and is also increasingly being used to access goods and services.

Although mobiles were originally used primarily in the business sector, a large market for the private use of mobile telephony has increasingly developed in the recent past. More and more mobile telephony subscribers use not only landline network access, but also mobile radio network access for private calls.

However, mobile radio subscribers having a company mobile cannot make private telephone calls at their own expense, since every call is automatically billed to the company, which is the actual customer of the mobile radio operator. Although these mobile radio subscribers could report their private calls to the company when the company has received the invoice, and the share of the invoice that relates to the private calls could then be deducted from the company employee's or mobile radio subscriber's earnings, this is associated with considerable administrative complexity for companies, particularly for larger companies. As a result of the resources that are tied up, this complexity sometimes results in more cost than would be saved through the employee paying for his private calls himself.

As an alternative to this, so as not to have to make his private calls at the company's expense, the mobile radio subscriber could additionally obtain another, private mobile. This practice would be a particularly disadvantageous solution, however. This is because the mobile radio subscriber would always have to carry two different mobiles with him in order to be able to be reached.

### SUMMARY OF THE INVENTION

It is accordingly an object of the invention to provide an improved mobile radio configuration and an improved method for debiting charges which allow a mobile radio subscriber to use one and the same mobile both for business and private purposes, that is to say, by way of example, to make calls which are paid for differently according to their business or private nature.

With the foregoing and other objects in view there is provided, in accordance with the invention, a configuration for debiting charges in a data and telecommunications network. The configuration includes: a terminal; a network server for communicating with the terminal; a billing server for producing charge tickets based on using the terminal when no prepaid signal has been sent from the terminal; a ticket memory for storing the charge tickets; an account memory for storing an electronic credit; an intelligent network system for checking whether the credit stored in the account memory allows an appropriate call time; and software configured for debiting charges from the electronic credit stored in the account memory when the terminal is connected and a prepaid signal has been sent from the terminal.

In accordance with an added feature of the invention, the credit stored in the account memory is a prepaid credit.

With the foregoing and other objects in view there is also provided, in accordance with the invention, a mobile radio network including: a mobile radio terminal; a network server for communicating with the terminal; a billing server for producing charge tickets based on using the terminal when no prepaid signal has been sent from the terminal; a ticket memory for storing the charge tickets; an account memory for storing an electronic credit; an intelligent network system for checking whether the credit stored in the account memory allows an appropriate call time; and software configured for debiting charges from the electronic credit stored in the account memory when the terminal is connected and a prepaid signal has been sent from the terminal.

With the foregoing and other objects in view there is also provided, in accordance with the invention, an electronic payment method for charge settlement for call charges for a terminal in a data and telecommunications network. The method includes steps of: when no prepaid signal has been sent from the terminal, forming a total by electronically summing charges for using the terminal taking account of tickets collected throughout a billing period; and when the prepaid signal has been sent from the terminal, directly debiting charges from an electronic credit during a call in which the terminal is used.

In accordance with an added mode of the invention, the prepaid signal is generated upon the input of a predefined digit or key sequence placed in front of a desired telephone number.

In accordance with an additional mode of the invention, the prepaid signal is transmitted when a particular key for a particular menu item on the terminal is operated.

In accordance with another mode of the invention, the call charges for using the data and telecommunications network differ per billing cycle or time cycle based on whether the prepaid signal is produced.

The invention embraces the fundamental concept that every mobile connected to a mobile radio network can use two different billing methods. In the case of one of these two methods, the charges incurred are recorded after the call using charge tickets. These tickets are collected and are invoiced to the mobile user as a whole at the end of a billing period, and payment proceeds via a bank. In the case of the second method, the call charges are deducted from a stored electronic credit if call setup has involved sending a defined signal from the mobile to a server belonging to the mobile radio network operator. The tickets are produced by a network server belonging to the mobile radio operator, and administration of the tickets is controlled by a billing server arranged centrally in the network. The billing and administration of the credit account is controlled by software implemented in the mobile radio operator's network.

One advantage is that the credit that is stored in the account memory and that is debited following a prior signal is a prepaid credit. This type of payment is based on the customer paying the mobile radio network operator for a particular credit in advance. The customer can then use services from the operator until his prepaid credit has been “used up”. This type of payment is attractive particularly because no basic charge that is independent of use is incurred. In addition, this provides the user with an opportunity for good cost control and does not impose an additional contractual tie on the customer.

Advantageous aspects of the inventive method emerge on the basis of the above description of the advantageous aspects of the inventive configuration.

One particular advantage arises for the inventive method if prepaid and “postpaid” payments are possible for one and the same mobile. Particularly in the case of company mobiles, this allows the company, as the mobile radio operator's customer, to pay for the call charges for business use at the end of a billing period. At the same time, the mobile radio subscriber or the employee with the company mobile has the option of using a prepaid account to accept and control the cost of his private use. In addition, this obviates the administrative complexity of subsequently ascertaining the invoice share for private use from a total invoice.

Advantageously, the signal or the private identifier for the nature of use, as business or private, is generated by a predefined digit or key sequence which is placed in front of the telephone number for the desired call. As an alternative to this, it is also advantageously possible for the signal used to be a transmitted signal resulting from the operation of a particular key or the selection of a particular menu item. The transmitted signal, whether produced by a dialing code or a particular key, allows a clear distinction to be drawn between two different characteristics of a call, for example, whether a business call or a private call is being made.

Preferably, the call charges per billing or clock cycle which are debited from the two different accounts for calls can also correspond to different amounts, since the mobile radio network operator needs to provide further resources for the additional payment method. Furthermore, this more flexible tariff option allows the mobile network operator to take into account the fact that the service it additionally provides is used only occasionally in the domain of private calls, in contrast to calls of a business nature.

Other features which are considered as characteristic for the invention are set forth in the appended claims.

Although the invention is illustrated and described herein as embodied in a configuration and method for debiting charges, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows a greatly simplified, schematic illustration of an embodiment of the inventive configuration, and

FIG. 2 shows a greatly simplified block diagram of the inventive method.

### DESCRIPTION OF THE PREFERRED EMBODIMENTS

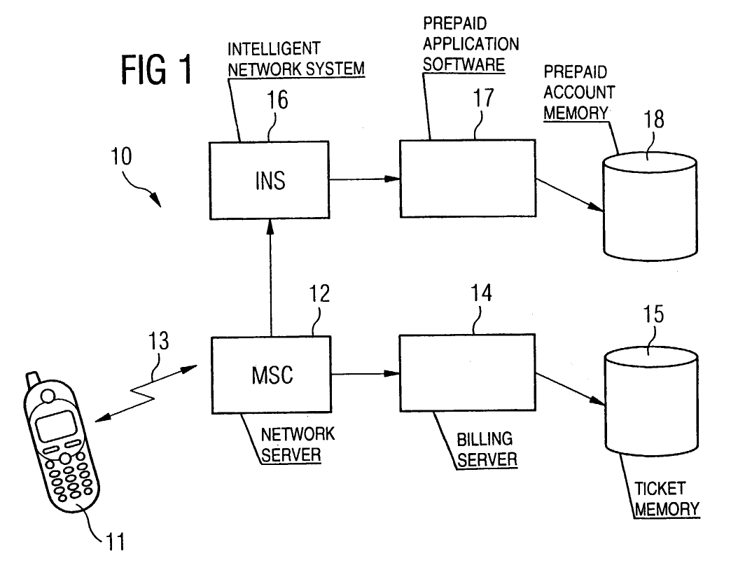

Referring now to the figures of the drawing in detail and first, particularly, to FIG. 1 thereof, there is shown a simplified illustration of an inventive configuration 10 for debiting charges in a mobile radio network using a mobile 11. In the example, the mobile radio network operator's customer is a company providing the mobile to an employee for business use.

Data communication between the mobile 11 and a network server or MSC 12 belonging to the mobile radio network operator is indicated by a jagged arrow 13. The network server 12 checks whether the requested call is to be paid for using the postpaid billing method or the prepaid billing method.

In the case of postpaid billing, the network server 12 sets up the desired call. Following the call, the server 12 produces a charge ticket for the currently ended call. It sends this ticket to the billing server 14 arranged centrally in the mobile radio network. The billing server collects the tickets in the ticket memory 15, and all of the tickets associated with a particular customer are invoiced to that customer at the end of a billing period, for example, at the end of a month.

In the case of prepaid billing, the network server passes the call request to an IN system (Intelligent Network system) 16. This system 16 uses the tariff structure, which is based on the call destination and the time of day, to check whether the prepaid account still has an account balance that allows an appropriate call time to the desired destination. If this is not possible because the prepaid credit has been totally or almost used up, the call request is rejected.

If there is reasonably sufficient prepaid credit available for such a call, the call is set up. In this case, the call charges are billed using prepaid application software 17 configured for deducting the charges that are incurred directly from an account in the prepaid account memory 18. This account stored in the account memory 18 is a prepaid account into which the employee pays a credit in advance. The mobile radio subscriber can use services from the network operator, which are charged to this account only for as long as the prepaid credit is in the black.

Although the illustration in FIG. 1 shows only one mobile 11, it is obvious that the mobile radio network operator's network server 12 can connect to any number of different mobiles belonging to the same customer or to different customers.

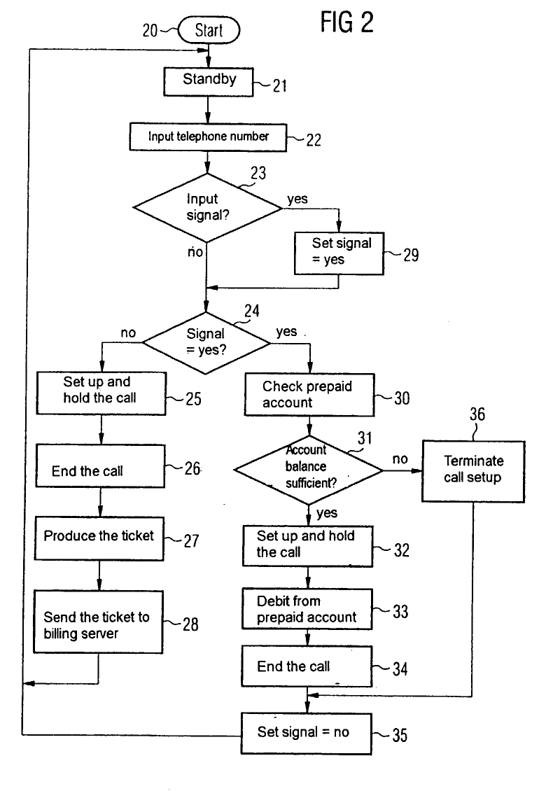

FIG. 2 schematically shows, by way of example, an embodiment of the inventive method for settling charges. The flowchart shown is described in detail below with reference to two different situations.

In the first situation, the mobile radio subscriber dials a telephone number for a call of a business nature. The procedure in the illustration starts at box 20, with “Start” which is understood to mean, for example, turning on the mobile or registering the mobile in a particular mobile radio network.

In box 21, the mobile is in a standby state from which a call can be set up. In box 22, the mobile radio subscriber inputs the desired call telephone number in the normal manner.

In decision box 23, a check is performed to determine whether the mobile radio subscriber has placed a dialing code or a particular digit sequence as a signal identifier in front of the desired call telephone number. In this example, no dialing code has been placed in front. Box 23 is therefore left via the “no” path.

The procedure is then continued in decision box 24. Here, a check is performed to determine whether a signal flag has been set to yes, which is not the case in this example. Box 24 is likewise left via the “no” path, and the procedure is continued in box 25.

In box 25, the desired call is set up or made and held. The connection or call is then ended in box 26. In box 27, a charge ticket is produced in line with the charges for this call. In box 28, this ticket is sent to the billing server arranged centrally in the mobile radio network. The billing server collects all of tickets and invoices them to the customer at the end of a billing period. In the example, the mobile radio subscriber is making a business call, which means that the charges are invoiced to the company, using a “postpaid” billing method. After the tickets have been sent in box 28, the mobile returns to the standby state in box 21.

In the second situation, the mobile radio subscriber dials a telephone number for a private call. The procedure in this situation differs from the procedure described above. In box 21, the mobile is—as in the first situation—in a standby state from which a call can be set up.

In box 22, the mobile radio subscriber inputs the desired call telephone number. However, he precedes the telephone number with a dialing code which signals to the network server that he wishes to pay for this call from the second account. Alternatively, the mobile can be produced with a signal key, which means that the mobile radio subscriber merely needs to operate one key more than usual, and not a relatively long digit sequence.

In decision box 23, as in the first situation, a check is performed to determine whether the mobile radio subscriber has placed a dialing code or a particular digit sequence as a signal identifier in front of the desired call telephone number. Since, this time, he does place such a dialing code in front, box 23 is left via the “yes” path, and the signal flag is now set to “yes” in box 29.

The procedure is then continued in decision box 24. Here, a check is performed to determine whether a signal flag has been set to “yes”, which is the case in this example. Box 24 is therefore left via the “yes” path, and the procedure is continued in box 30.

In box 30, an IN system (Intelligent Network system) checks the account balance in the customer's prepaid account with regard to tariffs specific to distance and time on the basis of the account data and the desired call. In decision box 31, this check provides a positive result, which means that the procedure is continued in box 32, or provides a negative result, which causes the procedure to be continued with box 36.

In the positive case, the call is then set up and held in box 32. At the same time, the charges incurred for this call are debited from a prepaid account, however, as indicated in box 33. Private calls made by the mobile radio subscriber are paid for from this prepaid account.

When the call has ended in box 34, the signal flag is reset to “no” in box 35. The mobile then returns to the standby state in box 21 again.

If the result of the check in box 31 is negative, call setup is rejected and terminated in box 36. Following termination of call setup in box 36, the signal flag is reset to “no” in box 35. The mobile then likewise returns to the standby state in box 21.

Besides the direct advantage to the mobile radio subscriber, who, as a result of the inventive configuration and of the inventive method, can use a company mobile for private calls as well, the mobile radio operator benefits from greater utilization of its network. In addition, this additional service allows it to distinguish itself from other mobile radio operators competing with it.

Furthermore, the company, which is a corporate customer of the mobile radio operator and provides its employees with such a mobile, can save call costs, since private calls made using the mobile are charged directly to the respective employee without tying up additional company resources, for example accounting, controlling entities.

In addition, the mobile radio subscriber can use the prepaid credit in the prepaid account not just for direct services from the mobile radio network operator, for example mobile telephony and short messages (SMS). He can also use the prepaid account, by way of example, for cashless payment for other payment transactions in daily life, for goods or services from other providers.

The embodiment of the invention is not limited to the aforementioned examples, variants and aspects, but rather is likewise possible in a large number of modifications which are within the scope of expert action, as specified in the claims. In particular, the method steps described above can also be put in a different order.

We claim:

1. A configuration for debiting charges in a data and telecommunications network, the configuration comprising:
a terminal;
a network server for communicating with said terminal;
a billing server for producing charge tickets based on using said terminal when no prepaid signal has been sent from said terminal;
a ticket memory for storing said charge tickets;
an account memory for storing an electronic credit;
an intelligent network system for checking whether said credit stored in said account memory allows an appropriate call time; and
software configured for debiting charges from said electronic credit stored in said account memory when said terminal is connected and a prepaid signal has been sent from said terminal.

2. The configuration according to claim 1, wherein said credit stored in said account memory is a prepaid credit.

3. A mobile radio network, comprising:
a mobile radio terminal;
a network server for communicating with said terminal;
a billing server for producing charge tickets based on using said terminal when no prepaid signal has been sent from said terminal;
a ticket memory for storing said charge tickets;
an account memory for storing an electronic credit;
an intelligent network system for checking whether said credit stored in said account memory allows an appropriate call time; and
software configured for debiting charges from said electronic credit stored in said account memory when said terminal is connected and a prepaid signal has been sent from said terminal.

4. An electronic payment method for charge settlement for call charges for a terminal in a data and telecommunications network, the method which comprises:
when no prepaid signal has been sent from the terminal, forming a total by electronically summing charges for using the terminal taking account of tickets collected throughout a billing period; and
when the prepaid signal has been sent from the terminal, directly debiting charges from an electronic credit during a call in which the terminal is used.

5. The method according to claim 4, which comprises generating the prepaid signal upon inputting a predefined digit or key sequence placed in front of a desired telephone number.

6. The method according to claim 4, which comprises transmitting the prepaid signal when a particular key for a particular menu item on the terminal is operated.

7. The method according to claim 4, wherein call charges for using the data and telecommunications network differ per billing cycle or time cycle based on whether the prepaid signal is produced.
